(19) United States
(12) Patent Application Publication
(10) Pub. No.: US 2013/0319556 A1
(43) Pub. Date: Dec. 5, 2013

(54) UNIVERSAL INTERFACE CONNECTION SYSTEM AND FLOW DIRECTING COUPLING SYSTEM AND MANIFOLD USING SAME

(71) Applicant: R.E. PRESCOTT CO., INC., (US)

(72) Inventor: Russell E. Prescott, Kingston, NH (US)

(73) Assignee: R.E. PRESCOTT CO., INC., Exeter, NH (US)

(21) Appl. No.: 13/684,388

(22) Filed: Nov. 23, 2012

Related U.S. Application Data
(60) Provisional application No. 61/563,176, filed on Nov. 23, 2011.

(51) Int. Cl. F16K 11/02

(52) U.S. Cl. CPC F16K 11/02
USPC 137/625.44; 137/798

(57) ABSTRACT

A universal interface connection system may be used to interconnect manifolds, valves, and other components in a water treatment system. A modular flow directing coupling system may be formed by the manifolds and used to direct a flow of water through water treatment devices in the water treatment system. Each of the manifolds may include one or more universal interface connection portions configured to connect with universal interface connection portions on other manifolds or to connect with other components. The universal interface connection portions may include a pair of spaced flanges configured to be engaged by a clip for holding the components together.

### CROSS-REFERENCE TO RELATED APPLICATIONS

The present application claims the benefit of U.S. Provisional Patent Application Ser. No. 61/563,176 filed Nov. 23, 2011, which is incorporated herein by reference.

### FIELD

The present invention relates to water supply systems and, more particularly, to a universal interface connection system and a flow directing coupling system for use in coupling water treatment devices to a water supply system.

### BACKGROUND

Water treatment systems are commonly used in water supply systems. In a residential water supply system, for example, water softeners, acid neutralizers, iron/manganese removal systems, arsenic removal systems, and aeration systems may be used to filter and/or treat the water being supplied from a water source (e.g., from a well or city water supply). Such systems may require coupling multiple filters, tanks and other devices into the system such that the water is filtered and/or treated before being supplied into the home. To connect such systems, the pipes, valves and other equipment often must be coupled together to direct water into the tanks and filters. Plumbing the pipes, valves and other equipment into an existing water supply system may be tedious and time consuming. Also, existing techniques for connecting components in water treatment systems may not provide adequate mechanical and fluid connections between the components as well as the flexibility to connect various components together in different arrangements.

### BRIEF DESCRIPTION OF THE DRAWINGS

These and other features and advantages will be better understood by reading the following detailed description, taken together with the drawings wherein:

FIG. 1 is a perspective view of a flow directing coupling system including manifolds with a universal interface connection system used in a water treatment system, consistent with one embodiment of the present disclosure;

FIG. 2 is a schematic view of the water treatment system of FIG. 1;

FIG. 3 is a perspective view of a connection manifold from the system shown in FIG. 1;

FIG. 4 is a top view of the connection manifold from the system shown in FIG. 1;

FIG. 5 is a side view of the connection manifold from the system shown in FIG. 1;

FIG. 6 is a bottom perspective view of the connection manifold from the system shown in FIG. 1 including adaptor couplers and fastening clips;

FIG. 7 is a perspective view of an in/out manifold from the system shown in FIG. 1;

FIG. 8 is an enlarged view of the in/out manifold coupled to the connection manifold;

FIG. 9 is a perspective, partially cross-sectional view a pivotable control valve assembly coupled to a modular flow directing coupling system using an universal interface connection system, consistent with another embodiment of the present disclosure;

FIG. 10 is a plan view of a bypass manifold coupled to a bypass valve, consistent with yet another embodiment of the present disclosure;

FIG. 11 is a perspective view of the bypass manifold shown in FIG. 10;

FIG. 12 is a top view of the bypass manifold shown in FIG. 10; and

FIG. 13 is a side view of the bypass manifold shown in FIG. 10.

### DETAILED DESCRIPTION

A universal interface connection system may be used to interconnect manifolds, valves, and other components in a water treatment system. A modular flow directing coupling system may be formed by the manifolds and used to direct a flow of water through water treatment devices in the water treatment system. Each of the manifolds may include one or more universal interface connection portions configured to connect with universal interface connection portions on other manifolds or to connect with other components. The universal interface connection portions may include a pair of spaced flanges configured to be engaged by a clip for holding the components together.

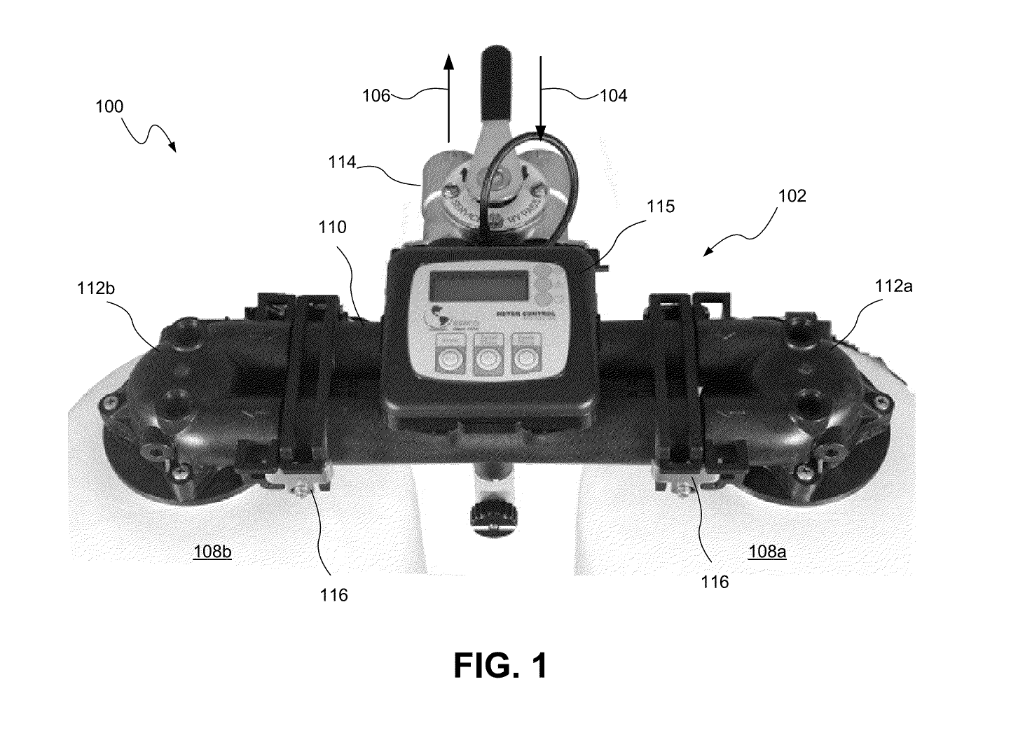

Referring to FIG. 1, a modular flow directing coupling system 102, consistent with one embodiment of the present disclosure, may be arranged using a universal interface connection system to form a water treatment system 100. The modular flow directing coupling system 102 directs water from a supply line 104 through one or more water treatment devices 108a, 108b to a delivery line 106. The supply line 104 may supply water from a water source such as a well or city water supply. The delivery line 106 may provide water to a building, such as a residential home. The water treatment system 100 may be coupled, for example, to a residential water supply system at the point of entry. The water treatment system 100 may also be configured for use in a commercial water supply system.

The modular flow directing coupling system 102 may include one or more manifolds and/or other components configured to facilitate installation of the water treatment system 100. In the illustrated embodiment, the modular flow directing coupling system 102 may include a connection manifold 110 coupled at each end to in/out manifolds 112a, 112b, respectively. The modular flow directing coupling system 102 may further include a valve 114 coupled between the first manifold 110 and the supply line 104 and delivery line 106. In an exemplary embodiment, the valve 114 may be a by-pass valve such as the type known to those skilled in the art for use in residential water systems. Each of the manifolds 110, 112a, 112b includes universal interface connection portions for coupling the manifolds 110, 112a, 112b to each another, to the valve 114, and to other components, as will be described in greater detail below.

A modular flow directing coupling system 102 may be used in any system where water is directed through a plurality of water treatment devices 108a, 108b. The modular flow directing coupling system 102 may eliminate additional plumbing connections for the additional water treatment devices. Examples of water treatment devices include, but are not limited to, water softeners, acid neutralizers, iron/manganese removal systems, arsenic removal systems, other contaminant removal systems, and aeration systems. Water treatment devices may also include water heaters or other devices that alter the temperature or other conditions of the water. Water treatment devices may further include tanks or other devices that store or allow water to pass through as part of a treatment process. The water treatment devices coupled using the modular flow directing coupling system 102 may include redundant water treatment devices (e.g., redundant arsenic removal systems) or may include different water treatment devices (e.g., an acid neutralizer and a water softener). One embodiment may include first and second filter tanks including a filter medium that removes or reduces the level of contaminants in the water as the water flows through the medium, such as the type disclosed in greater detail in U.S. Patent Application Publication No. 2007/0045160, incorporated herein by reference. In an arsenic removal system, for example, the filter medium may include a hybrid ion exchange resin such as the type available under the name LayneRT™ from SolmeteX Inc.

Modular flow directing coupling systems consistent with the present disclosure may also include flow monitoring and control devices (e.g., incorporated into the manifold blocks) to monitor the flow of water through various points within the systems. Flow monitoring devices may include pressure gauges (not shown) coupled to the passageways in the manifold blocks to monitor water pressure in the passageways, a flow meter or sensor 115 to sense flow, and/or a flow monitor (not shown) to monitor flow characteristics such as flow volume and rate. Manifolds may further include taps (not shown) fluidly coupled to one or more of the passageways to allow water to be tapped or removed as the water flows into and out of the tanks. Manifolds may further include a flow control device (not shown) located in one or more passageways to control flow of water through the passageway.

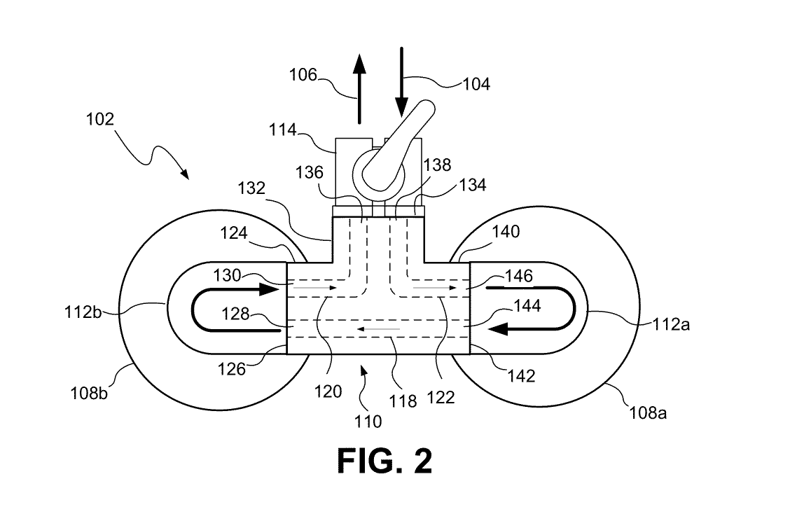

The manifolds 110, 112a, 112b, may be arranged according to various configurations, for example, depending upon the location of the supply line 104, the location of the delivery line 106, the desired location of the water treatment devices 108a, 108b, and/or the existing plumbing. For example, as shown in FIG. 2, the manifolds 110, 112a, 112b, may be coupled together to form the modular flow directing coupling system 102 configured to direct water from the supply line 104 through water treatment devices 108a, 108b coupled to the system and from the water treatment devices to the delivery line 106. In particular, the by-pass valve 114 is coupled between the centrally located connection manifold 110 and the supply line 104 and delivery line 106. The water treatment devices 108a, 108b are coupled to the in/out manifolds 112a, 112b, respectively, and the in/out manifolds 112a, 112b are coupled to opposing ends of the connection manifold 110. The water passes from the supply line 104 and passes through the valve 114, through the manifolds 110, 112a, 112b, and through the water treatment devices 108a, 108b, as indicated by the arrows.

As shown, the connection manifold 110 has a generally T-shaped body portion defining passageways 118, 120, 122. The connection manifold 110 may include inlet/outlet ends 124, 132, 140 having inlet/outlet sides 126, 134, 142. In this embodiment, the passageway 118 extends between two of the inlet/outlet sides 126, 142, the passageway 120 extends between two of the inlet/outlet sides 126, 134, and the passageway 122 extends between two of the inlet/outlet sides 134, 142. The inlet/outlet sides 126, 134, 142 each provide an inlet or an outlet to the passageways 120, 122 extending to the corresponding sides 126, 134, 142. In the illustrated embodiment, for example, the inlet/outlet side 126 defines an opening 128 to passageway 118 and an opening 130 to passageway 120, inlet/outlet side 134 defines an opening 136 to passageway 120 and an opening 138 to passageway 122, and inlet/outlet side 142 defines an opening 144 to passageway 118 and an opening 146 to passageway 122. The openings 128, 130, 136, 138, 144, 146 may act as inlets or outlets with respect to the passageways 118, 120, 122 depending upon the configuration.

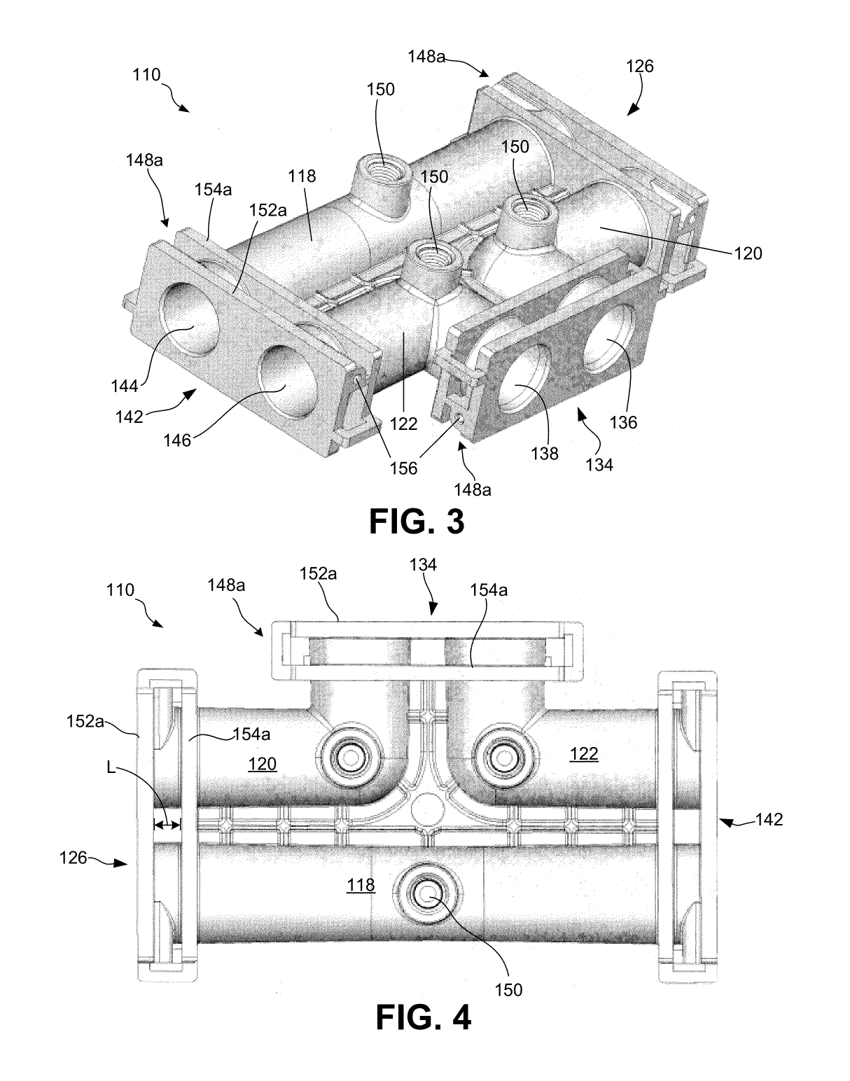

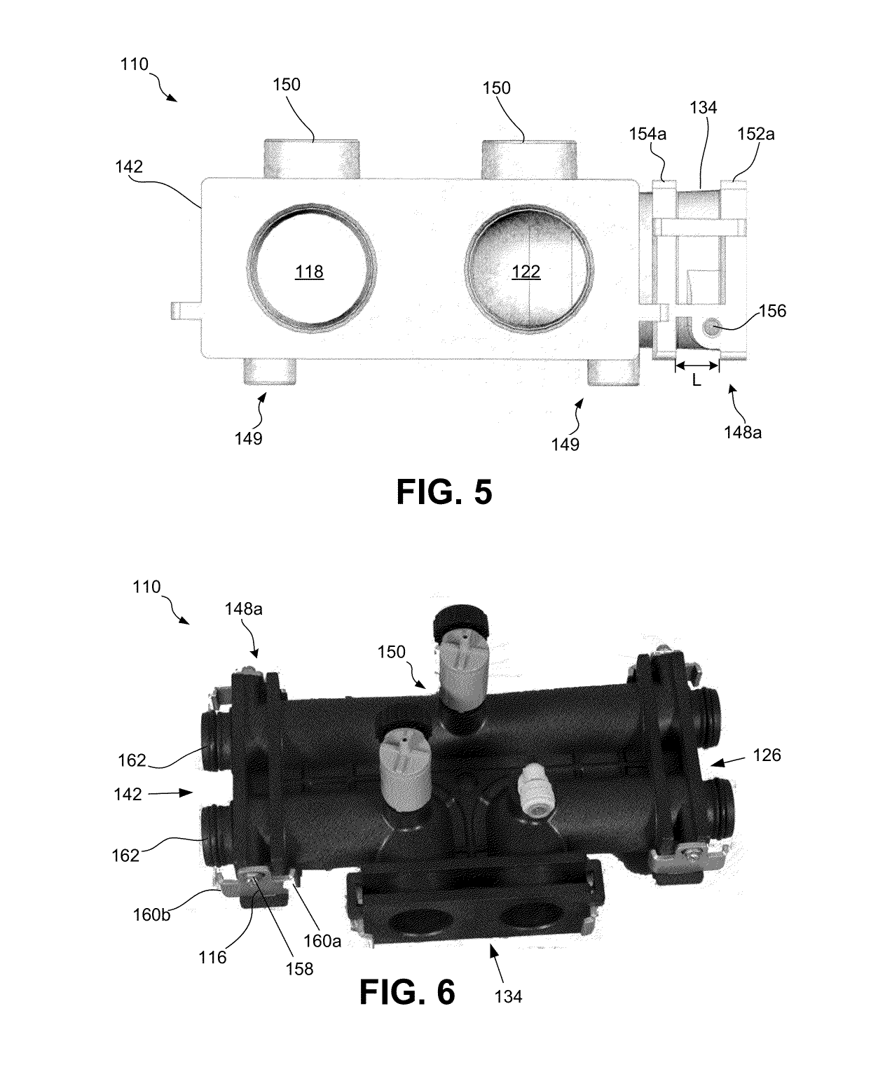

One embodiment of the connection manifold 110 is shown in greater detail in FIGS. 3-6. As shown, the inlet/outlet sides 126, 134, 142 may each include a universal interface connection portion 148a. As described in greater detail herein, other manifolds and components may also include a universal interface connection portion on portions thereof, whereby the components may be coupled to one another by way of the universal interface connection system. The connection manifold 110 may further include coupling portions 149 (see FIG. 5) defined on a portion of the manifold 110 for mounting components, such as a flow monitoring device 115 (see FIG. 1) to the connection manifold 110 and in communication with the fluid flowing through the passageways 118, 120, 122. In the illustrated embodiment, the coupling portions 149 may include threaded apertures configured to receive and retain a portion of the component to be fixed thereto. The connection manifold 110 may also include ports 150 in fluid communication with the respective passageways 118, 120, 122 for connecting to taps or other such components.

As previously discussed, the modular flow directing coupling system 102 also includes a universal interface connection system used to couple the manifolds 110, 112a, 112b to each other and to other components. In particular, the universal interface connection system includes the universal interface connection portions 148a on one or more of the inlet/outlet sides 126, 134, 142 of the connection manifold 110. The universal interface connection portions 148a include a first flange portion 152a and a second flange portion 154a positioned a length L from the first flange portion 152a. The first and second flange portions 152a, 154a may be configured to accommodate fastening clips 116 (shown in FIGS. 1 and 6) for coupling the interface connection portion 148a of the connection manifold 110 to interface connection portions of other manifolds or components, such as the in/out manifolds 112a, 112b (shown in FIGS. 1 and 8) and the valve 114.

As shown in FIG. 6, one or more fastening clips 116 may be used to secure the connection manifold 110 to other components of the coupling system 102. In particular, a fastening clip 116 may be secured to a portion of the universal interface connection portion 148a with an associated screw 158 or other threaded fastener fastened into an associated aperture 156 defined on the interface connection portion 148a. One end 160a of the fastening clip 116 may be angled to engage a portion of the first or second flange portions 152a, 154a of the interface connection portion 148a when secured thereto. An opposing end 160b of the fastening clip 116 may be similarly angled and configured to engage a portion of a first or second flange portion of an opposing interface connection portion of another manifold or component when the connection manifold 110 is coupled to such a component, thereby securing the connection manifold 110 to the component, as described in greater detail below.

Additionally, fluid adapter couplers 162 may be positioned between the connection manifold 110 and other components of the coupling system 102 to fluidly couple the connection manifold 110 to other components. The couplers 162 may include portions that extend into respective passageways of the connection manifold 110 and the other components to be coupled. One example of the couplers 162 include the adapter couplings available from Fleck Controls, Inc. under Fleck P/N 19228. O-rings may be positioned around each of the respective coupler portions to seal against the inner surfaces of the passageways. One example of the O-rings include adapter coupler O-rings available from Fleck Controls, Inc. under Fleck P/N 13305.

When securing the connection manifold 110 to other components, such as the in/out manifolds 112a, 112b, via the fastening clips 116, the couplers 162 may be sandwiched in between. Having two flange portions allows the universal interface connection system to accommodate different types of adapter couplers that provide different spacings between the manifold and other component (e.g., other manifold or valve) being coupled. The adapter coupler available from Fleck Controls, Inc. under Fleck P/N 19228, for example, provides a longer distance between the manifold and other component and allows the fastening clip to be screwed into a portion of the coupler. The adapter coupler available from Fleck Controls, Inc. under Fleck P/N 15078 provides a shorter distance and does not allow the fastening clip to be screwed into the coupler. Using the universal interface connection system with two flanges thus allows the clips to engage either of the two flanges depending upon the spacing and provides versatility in coupling the manifolds together with different adapter couplers.

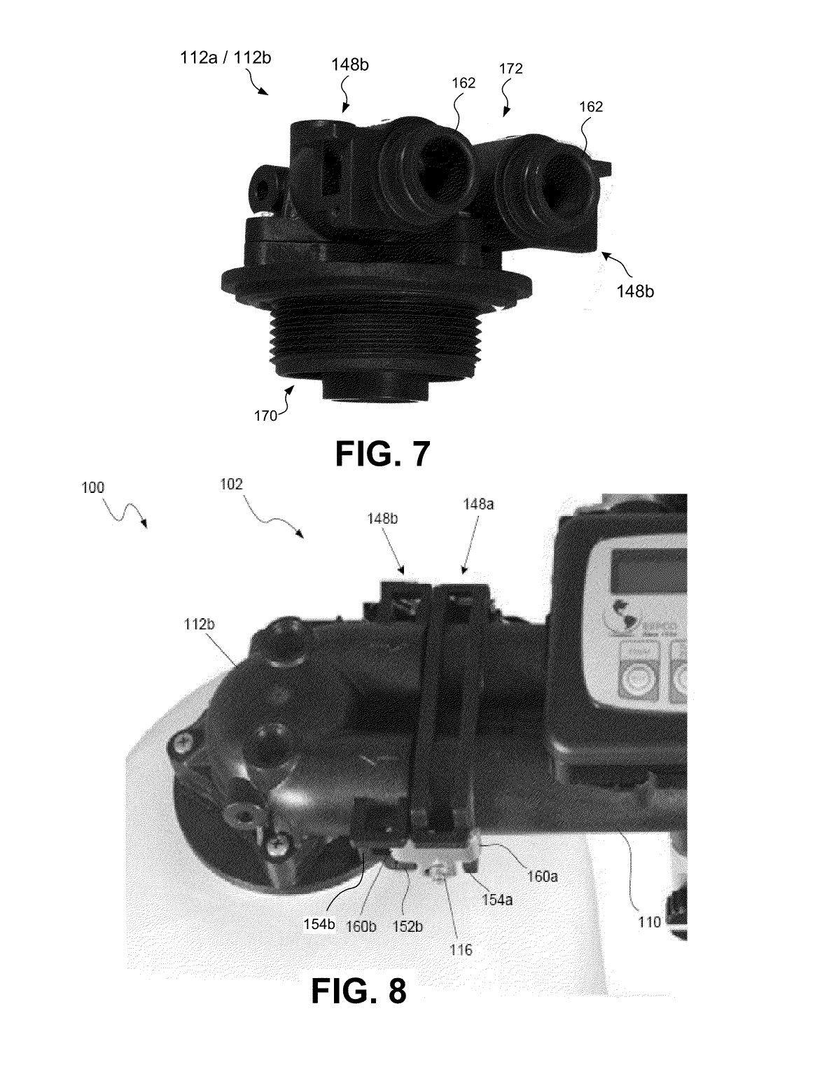

Referring to FIGS. 7 and 8, one embodiment of the in/out manifolds 112a, 112b is shown and described in greater detail. Each of the in/out manifolds 112a, 112b may include first and second passageways extending between inlet/outlet sides 170, 172. A first inlet/outlet side 170 may be configured to be coupled to a water treatment device, for example, by threadably coupling. A second inlet/outlet side 172 includes a universal interface connection portion 148b similar to the interface connection portion 148a of the connection manifold 110. In particular, the interface connection portion 148b of the in/out manifolds 112a, 112b may include a first flange portion 152b and a second flange portion 154b configured to accommodate fastening clips 116 for coupling the interface connection portion 148b to at least the interface connection portion 148a of the connection manifold 110, thereby securing the in/out manifolds 112a, 112b to the connection manifold 110. Additionally, in/out manifolds 112a, 112b may be configured to receive fluid adapter couplers 162 in a similar fashion as described with regard to the connection manifold 110.

As shown in FIG. 8, the in/out manifold 112b may be securely coupled to the connection manifold 110 with fastening clips 116. In particular, one end 160a of the fastening clip 116 may engage a portion of second flange portion 154a of the interface connection portion 148a of the connection manifold 110 and the opposing end 160b of the fastening clip 116 may engage a portion of the first flange portion 152b of the interface connection portion 148b of the third manifold 112b, thereby securing the connection manifold 110 to the in/out manifold 112b. In other embodiments, the fastening clips may have varying configurations and may engage various portions of the respective interface connection portions when coupling manifolds and/or other components of the coupling system 102 to one another.

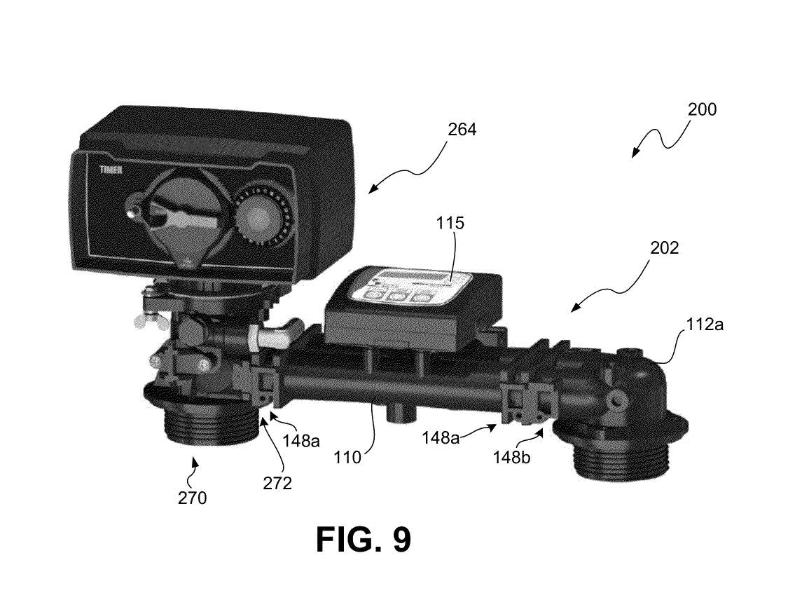

Referring to FIG. 9, a modular flow directing coupling system 202, consistent with another embodiment of the present disclosure, may also be coupled with a universal interface connection system to a pivotable control valve assembly 264. The pivotable control valve assembly 264 may be coupled to a water treatment apparatus (not shown) such that the pivotable control valve assembly 264 is pivotable to a plurality of different user access positions. The pivotable control valve assembly 264 may control flow in to and out of the water treatment apparatus, for example, during various water treatment cycles. One example of the pivotable control valve assembly 264 is described in greater detail in U.S. Patent Application Publication No. 2009/0230341, which is fully incorporated herein by reference. In this embodiment of the coupling system 202, the connection manifold 110 is coupled to an in/out manifold 112a at one end and to the pivotable control valve assembly 264 at the other end.

The pivotable control valve assembly 264 may include a first inlet/outlet side 270 configured to be coupled to the water treatment device and a second inlet/outlet side 272 configured to be coupled to the connection manifold 110. The second inlet/outlet side of the pivotable control valve assembly 264 may include at least one flange configured to be engaged by a fastening clip (not shown in FIG. 9) similar to engaging the flange on the in/out manifold as described above. Thus, the second inlet/outlet side 272 of the pivotable control valve assembly 264 may be secured to the universal interface connection portion 148b of the connection manifold 110. The second inlet/outlet side 272 of the pivotable control valve assembly 264 may also include a universal interface connection portion similar to the interface connection portions 148a and 148b of the connection manifold 110 and the in/out manifolds 112a,112b.

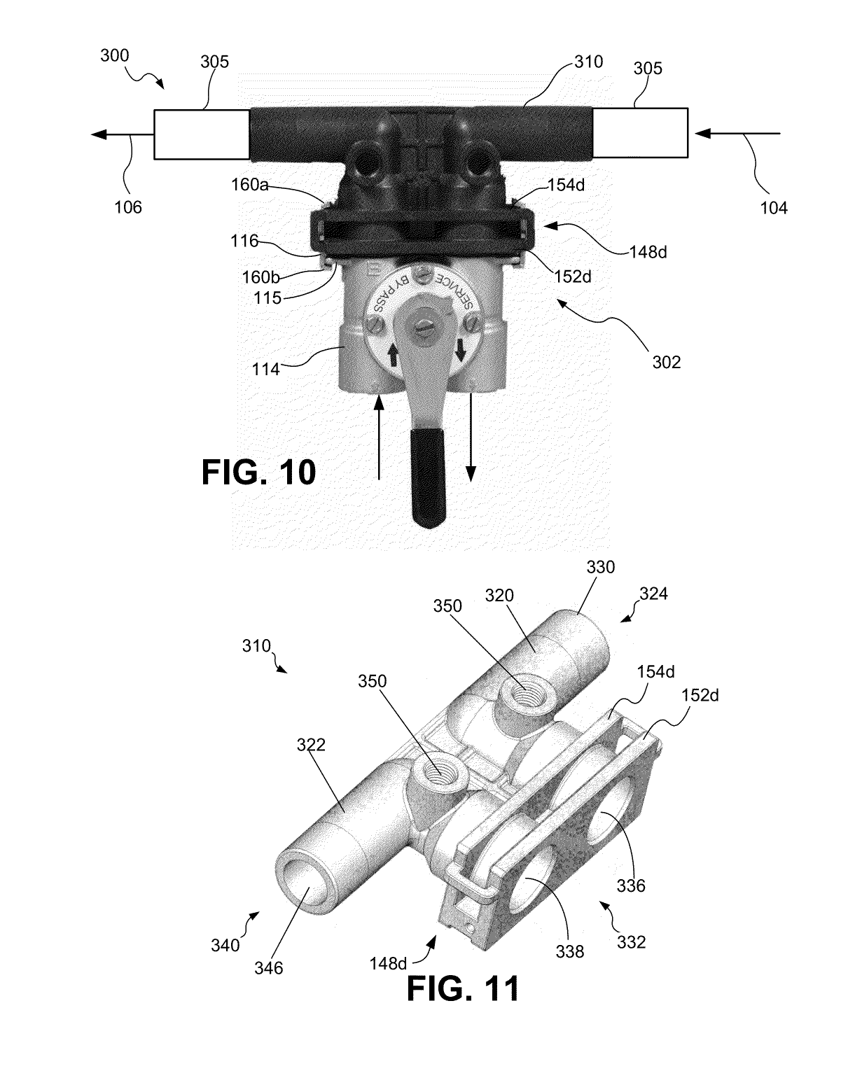

FIG. 10 shows another embodiment of a modular flow directing coupling system 302 including a bypass valve 114 and a bypass manifold 310. Similar to the coupling system 102 described above, the modular flow directing coupling system 302 may direct water from a supply line 104 to a delivery line 106. In particular, the bypass manifold 310 may be configured to bypass a portion of piping 305 directing water from the supply line 104 to the delivery line 106 and may be configured to direct water from the supply line 104 to a water treatment device or other component as described herein. The valve 114 coupled to the bypass manifold 310 may be configured to couple the supply line 104 to, for example, a water treatment device. In the illustrated embodiment, the water passes from the supply line 104 into piping 305 and passes through the bypass manifold 310 to the valve 114. The valve 114 may then supply the water to a water treatment device or other component (not shown). The valve 114 may then direct water back to the bypass manifold 310 and to the piping 305 to the delivery line 106, as indicated by the arrows.

As shown, the bypass manifold 310 may include a universal interface connection portion 148d similar to the interface connection portions 148a, 148b described above. In particular, the interface connection portion 148d of the bypass manifold 310 may include a first flange portion 152d and a second flange portion 154d configured to accommodate fastening clips 116 for coupling the interface connection portion 148d to the bypass valve 114 or other components of the coupling system 302. Additionally, the interface connection portion 148d of the bypass manifold 310 may be configured to receive fluid adapter couplers 162 in a similar fashion as described with regard to the connection manifold 110.

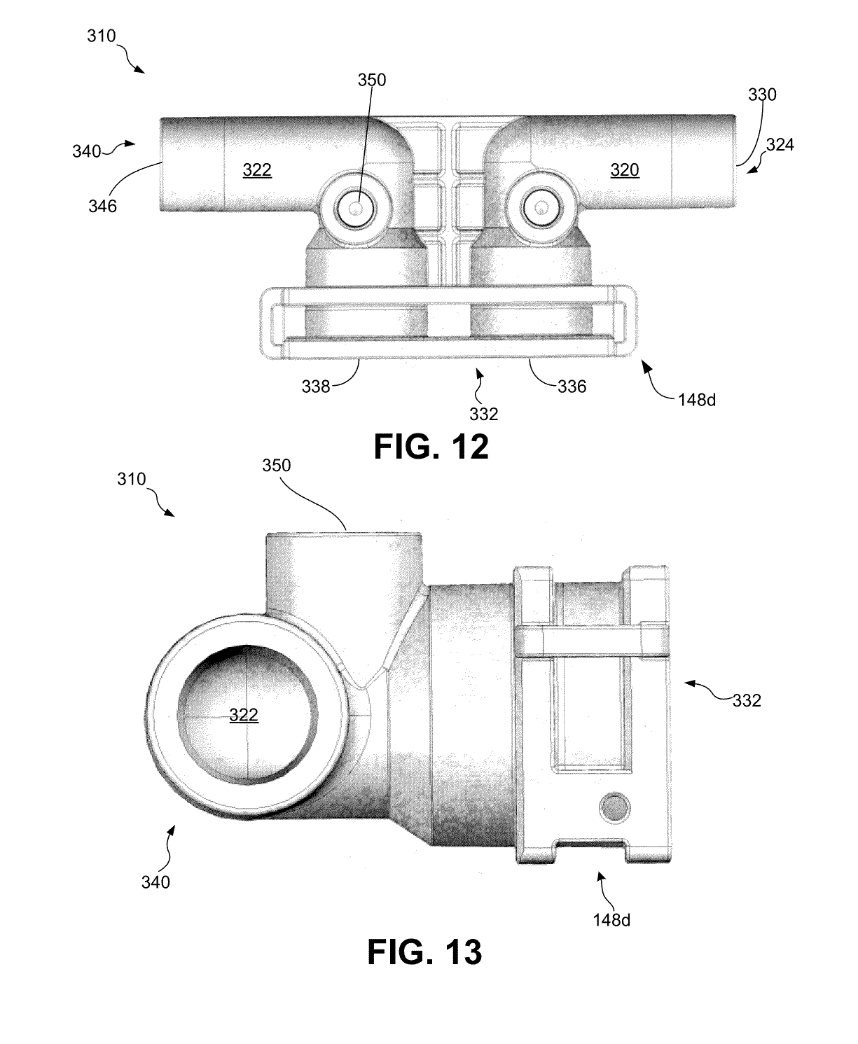

FIGS. 11-13 show the bypass manifold 310 in greater detail. As shown, the bypass manifold 310 has a generally T-shaped body portion defining passageways 320, 322. The bypass manifold 310 may include inlet/outlet sides 332, 324, 340. In this embodiment, the passageway 320 extends between the inlet/outlet side 332 and the inlet/outlet side 324, and the passageway 322 extends between the inlet/outlet side 332 and the inlet/outlet side 340. In the illustrated embodiment, for example, the inlet/outlet side 324 defines an opening 330 to passageway 320, the inlet/outlet side 332 defines an opening 338 to passageway 322 and an opening 336 to passageway 320, and the inlet/outlet side 340 defines an opening 346 to passageway 322. The openings 330, 336, 338, 346 may act as inlets or outlets with respect to the passageways 320, 322 depending upon the configuration.

In the illustrated embodiment, the bypass manifold 310 may be coupled to the valve 114 via fastening clips 116 secured to a portion of the interface connection portion 148d of the bypass manifold 310. In particular, one end 160a of the fastening clip 116 may be angled to engage a portion of second flange portion 154d of the interface connection portion 148d of the bypass manifold 310 and the opposing end 160b of the fastening clip 116 may be angled to engage a protrusion 115 of the valve 114, thereby securing the bypass manifold 310 to valve 114. Additionally, fluid adapter couplers may be positioned between the bypass manifold 310 and the valve 114 when coupled to one another.

Accordingly, the modular water directing coupling system with the universal connection system, consistent with the embodiments described herein, facilitates the interconnection of various manifolds and valves in a water delivery and/or water treatment system. The universal connection system may, for example, simplify the plumbing required to install various type water treatment systems into a residential water supply system.

Consistent with an embodiment, flow directing coupling system includes at least one manifold including at least two passageways extending between at least two inlet/outlet sides and including at least one universal interface connection portion located on one of the inlet/outlet sides. The universal interface connection portion includes first and second flange portions spaced at a predefined spacing and at least one clip configured to be secured to at least one of the flanges and configured to engage a flange on another manifold or component to connect the manifold with the other manifold or component.

Consistent with another embodiment, water treatment system includes at least one water treatment device and a pivotable control valve assembly coupled to the water treatment device such that the pivotable control valve assembly is pivotable to a plurality of different user access positions relative to the water treatment device. The pivotable control valve assembly includes a first inlet/outlet side coupled to the water treatment apparatus and a second inlet/outlet side. The water treatment system also includes at least one manifold including at least two passageways extending between at least two inlet/outlet sides and including at least one universal interface connection portion located on one of the inlet/outlet sides. The universal interface connection portion includes first and second flange portions spaced at a predefined spacing and at least one clip secured to at least one of the flanges and engaging a flange on the second inlet/outlet side of the pivotable control valve assembly.

The water treatment systems 100-300 illustrated are only examples of different configurations formed using modular water directing coupling systems disclosed herein. Those of ordinary skill in the art will recognize that the manifolds, and optionally the valves, may be coupled in any number of configurations.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A flow directing coupling system comprising:
at least one manifold including at least two passageways extending between at least two inlet/outlet sides and including at least one universal interface connection portion located on one of the inlet/outlet sides, the universal interface connection portion comprising:
first and second flange portions spaced at a predefined spacing; and
at least one clip configured to be secured to at least one of the flanges and configured to engage a flange on another manifold or component to connect the manifold with the other manifold or component.

2. The flow directing coupling system of claim 1 wherein the clip is secured to one of the flanges with a threaded fastener.

3. The flow directing coupling system of claim 1 wherein the clip includes engaging ends that are angled to engage the flange portions.

4. The flow directing coupling system of claim 1 wherein the at least one manifold includes two manifolds coupled using the universal interface connection portion on each of the manifolds.

5. The flow directing coupling system of claim 1 further comprising a pivotable control valve assembly configured to be coupled to a water treatment device such that the pivotable control valve assembly is pivotable to a plurality of different user access positions relative to the water treatment device, and wherein the pivotable control valve assembly includes a first inlet/outlet side configured to be coupled to the water treatment apparatus and a second inlet/outlet side configured to be coupled to an inlet/outlet side on the manifold, wherein the second inlet/outlet side includes at least one flange for connecting to the universal interface connection portion on the manifold.

6. The flow directing coupling system of claim 5 wherein the manifold is a connection manifold comprising:
a body portion defining three passageways through the body portion;
three inlet/outlet sides on the body portion, each of the inlet/outlet sides defining openings to two of the passageways, wherein the openings are configured to act as an inlet to or outlet from the respective passageways; and
a universal interface connection portion defined on each of the three inlet/outlet sides.

7. The flow directing coupling system of claim 1 wherein the manifold is a connection manifold comprising:
a body portion defining three passageways through the body portion;
three inlet/outlet sides on the body portion, each of the inlet/outlet sides defining openings to two of the passageways, wherein the openings are configured to act as an inlet to or outlet from the respective passageways; and
a universal interface connection portion defined on each of the three inlet/outlet sides.

8. The flow directing coupling system of claim 7 wherein the at least one manifold further includes an in/out manifold configured to be coupled to the connection manifold, the in/out manifold comprising:
a body portion defining two passageways through the body portion; and
first and second inlet/outlet sides on the body portion defining openings to the respective passageways, wherein the first inlet/outlet side is configured to be coupled to a water treatment apparatus and wherein the second inlet/outlet side includes the universal interface connection portion for connecting to the connection manifold.

9. The flow directing coupling system of claim 8 further comprising a bypass valve configured to be coupled to one of the inlet/outlet sides of the connection manifold.

10. The flow directing coupling system of claim 1 wherein the manifold is an in/out manifold comprising:
a body portion defining two passageways through the body portion; and
first and second inlet/outlet sides on the body portion defining openings to the respective passageways, wherein the first inlet/outlet side is configured to be coupled to a water treatment apparatus and wherein the second inlet/outlet side includes the universal interface connection portion for connecting to another manifold.

11. The flow directing coupling system of claim 1 wherein the manifold is a bypass manifold comprising:
a body portion defining two passageways through the body portion;
three inlet/outlet sides defining openings to the respective passageways, wherein a first of the inlet/outlet openings defines openings to both of the passageways and includes the universal interface connection portion, and wherein second and third of the inlet/outlet openings define an opening to one of the passageways on opposite sides of the body portion.

12. The flow directing coupling system of claim 1 further comprising fluid couplers configured to extend into the passageways of the manifold for fluidly coupling the manifold to another manifold or component.

13. The flow directing coupling system of claim 7 wherein the connection manifold includes one or more taps fluidly coupled to at least one of the passageways.

14. The flow directing coupling system of claim 7 wherein the connection manifold includes a fluid monitor device coupled to the connection manifold in fluid communication with at least one of the passageways.

15. A water treatment system comprising:
at least one water treatment device;
a pivotable control valve assembly coupled to the water treatment device such that the pivotable control valve assembly is pivotable to a plurality of different user access positions relative to the water treatment device, wherein the pivotable control valve assembly includes a first inlet/outlet side coupled to the water treatment apparatus and a second inlet/outlet side;
at least one manifold including at least two passageways extending between at least two inlet/outlet sides and including at least one universal interface connection portion located on one of the inlet/outlet sides.

16. The water treatment system of claim 15 the universal interface connection portion comprising:
first and second flange portions spaced at a predefined spacing; and
at least one clip secured to at least one of the flanges and engaging a flange on the second inlet/outlet side of the pivotable control valve assembly.

17. The water treatment system of claim 15 wherein the manifold is a connection manifold comprising:
a body portion defining three passageways through the body portion;
three inlet/outlet sides on the body portion, each of the inlet/outlet sides defining openings to two of the passageways, wherein the openings are configured to act as an inlet to or outlet from the respective passageways; and
a universal interface connection portion defined on each of the three inlet/outlet sides, wherein a first one of the inlet/outlet sides is connected to the pivotable valve assembly.

18. The water treatment system of claim 17 wherein the at least one manifold further includes an in/out manifold coupled to the connection manifold, the in/out manifold comprising:
a body portion defining two passageways through the body portion; and
first and second inlet/outlet sides on the body portion defining openings to the respective passageways, wherein the first inlet/outlet side is configured to be coupled to a water treatment apparatus and wherein the second inlet/outlet side includes the universal interface connection portion for connecting to the second one of the inlet/outlet sides on the connection manifold.

19. The water treatment system of claim 18 further comprising a bypass valve coupled to the third inlet/outlet side of the connection manifold.
